(19) United States
(12) Patent Application Publication
(10) Pub. No.: US 2023/0312885 A1
(43) Pub. Date: Oct. 5, 2023

(54) Cellulose Ester Polymer Product With Increased Melt Flow Rate

(71) Applicant: Celanese International Corporation, Irving, TX (US)

(72) Inventors: Rongfu Li, Narrows, VA (US); Michael Combs, Shady Spring, WV (US); Ronald Hughes, Narrows, VA (US)

(21) Appl. No.: 18/120,201

(22) Filed: Mar. 10, 2023

Related U.S. Application Data
(60) Provisional application No. 63/319,054, filed on Mar. 11, 2022.

(51) Int. Cl. C08L 1/12

(52) U.S. Cl. CPC C08L 1/12

(57) ABSTRACT

A polymer composition comprising a cellulose ester polymer in combination with a chain scission agent. The chain scission agent reacts with the cellulose ester polymer and decreases the intrinsic viscosity of the polymer. In this manner, the flow properties of the cellulose ester polymer can be dramatically improved. For instance, the melt flow rate of the polymer can increase making the polymer more amenable to molding processes.

### RELATED APPLICATIONS

The present application is based upon and claims priority to U.S. Provisional Pat. Application Serial No. 63/319,054, having a filing date of Mar. 11, 2022, which is incorporated herein by reference.

### BACKGROUND

Each year, the global production of plastics continues to increase. Over one-half of the amount of plastics produced each year are used to produce plastic bottles, containers, drinking straws, and other single-use items. The discarded, single-use plastic articles, including plastic drinking bottles, are typically not recycled and end up in landfills. In addition, many of these items are not properly disposed of and end up in streams, lakes, and oceans around the world.

In view of the above, those skilled in the art have attempted to produce plastic articles made from biodegradable polymers. Many biodegradable polymers, however, lack the physical properties and characteristics of conventional polymers, such as polypropylene and/or polyethylene terephthalate.

Cellulose esters have been proposed in the past as a replacement to some petroleum-based polymers or plastics. Cellulose esters, for instance, are generally considered environmentally friendly polymers because they are recyclable, degradable and derived from renewable resources, such as wood pulp. Problems have been experienced, however, in melt processing cellulose ester polymers, such as cellulose acetate polymers. The polymer materials are relatively stiff and have relatively poor elongation properties. In addition, the melt temperature of cellulose ester polymers is close to the degradation temperature of the polymer, which requires careful control over temperatures during melt processing. Consequently, cellulose esters are typically combined with a plasticizer in order to improve the melt processing properties of the material.

Adding substantial amounts of plasticizer to the cellulose ester polymer, however, can produce various drawbacks. For instance, adding the plasticizer lowers the melting temperature of the composition. Relatively large amounts of plasticizer can also reduce modulus and stiffness. In addition, the plasticizer can have a negative impact on the heat deflection temperature.

In view of the above, a need currently exists for a method of improving the melt processing characteristics of cellulose ester polymers. A need also exists for cellulose ester polymer compositions that can be formulated with higher melt flow rates and/or lower intrinsic viscosities. Such compositions may be melt processed without having to add significant amounts of plasticizer if desired.

### SUMMARY

In general, the present disclosure is directed to a polysaccharide ester polymer composition, particularly a cellulose ester polymer composition, that has improved flow properties. The improved flow properties not only greatly facilitate melt processing of the polymer composition but can also produce molded articles having one or more improvements in physical properties and/or one or more improvements in the appearance of the molded article. In general, a cellulose ester polymer is combined with a chain scission agent that reduces the intrinsic viscosity of the cellulose ester polymer and increases its melt flow rate. In one aspect, the modified cellulose ester polymer can be combined with lower amounts of plasticizer in producing molded articles.

For example, in one embodiment, the present disclosure is directed to a polymer composition comprising a cellulose ester polymer. The cellulose ester polymer is present in the polymer composition in an amount greater than about 20% by weight, such as in an amount greater than about 40% by weight, such as in an amount greater than about 50% by weight, such as in an amount greater than about 60% by weight, such as in an amount greater than about 70% by weight, such as in an amount greater than about 80% by weight, such as in an amount greater than about 90% by weight. The cellulose ester polymer is combined with a plasticizer and a chain scission agent. The chain scission agent comprises an acidic species having a Pka value of from about 1 to about 8. The chain scission agent is present in the polymer composition in an amount sufficient to increase the melt flow rate of the composition by greater than about 20% in relation to the same composition without the chain scission agent and at the same cellulose ester polymer levels.

For example, the chain scission agent can increase the melt flow rate of the polymer composition by greater than about 30%, such as by greater than about 50%, such as by greater than about 100%, such as by greater than about 200%, such as by greater than about 300%, such as by greater than about 400%, such as by greater than about 500%, such as by greater than about 600%, such as by greater than about 700%, such as by greater than about 800%, and generally less than about 2,000%.

The chain scission agent can lower the intrinsic viscosity of the cellulose ester polymer. For example, the cellulose ester polymer can have an initial intrinsic viscosity of greater than about 1.5, such as greater than about 1.6, and can have a final intrinsic viscosity after being combined with the chain scission agent of less than about 1.4, such as less than about 1.3, and generally greater than about 1. For example, the intrinsic viscosity of the cellulose ester polymer can be decreased by greater than about 5%, such as greater than about 10%, such as greater than about 15%, such as greater than about 20%, and generally less than about 80%.

The chain scission agent is an acidic species that, in one aspect, has at least one Pka value of from about 2.5 to about 6, such as from about 3 to about 5.5. In one aspect, the chain scission agent is an acidic species having terminal hydroxyl groups, such as carboxyl groups. For example, the chain scission agent can be an organic acid. In one particular embodiment, the chain scission agent comprises citric acid. Alternatively, the chain scission agent can comprise stearic acid, oxalic acid, or combinations thereof. In still other embodiments, the chain scission agent can be palmitic acid, linoleic acid, lactic acid, acetic acid, formic acid, malic acid, ascorbic acid, peracetic acid, alone or in combination with any of the other organic acids described above. The chain scission agent can be present in the polymer composition generally in an amount from about 0.001 % by weight to about 10% by weight, such as from about 0.01% by weight to about 5% by weight, such as from about 0.01% by weight to about 4.5% by weight.

The cellulose ester polymer modified in accordance with the present disclosure can contain cellulose diacetate. The cellulose ester polymer can have a degree of substitution, in one aspect, of from about 1.5 to about 2.8, such as from about 2.1 to about 2.6.

The cellulose ester polymer can be present in the polymer composition generally in an amount from about 55% to about 95% by weight. One or more plasticizers can be incorporated into the polymer composition generally in an amount from about 5% to about 40% by weight. In various embodiments, the amount of plasticizer can be less than about 25% by weight, such as less than about 23% by weight, such as less than about 20% by weight, such as less than about 18% by weight, such as less than about 16% by weight, such as less than about 14% by weight, such as less than about 12% by weight, such as less than about 10% by weight. In one embodiment, the plasticizer can comprise polyethylene glycol. In another embodiment, the plasticizer can comprise triacetin. In still another embodiment, the plasticizer can comprise a biodegradable polymer, such as polycaprolactone.

Other plasticizers that may be incorporated into the polymer composition include tris(clorisopropyl) phosphate, tris(2-chloro-1-methylethyl) phosphate, glycerin, monoacetin, triethyl citrate, acetyl triethyl citrate, a phthalate, an adipate, polyethylene glycol, triacetin, diacetin, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, aromatic diol, a substituted aromatic diol, an aromatic ether, tripropionin, tribenzoin, glycerin esters, glycerol tribenzoate, glycerol acetate benzoate, polyethylene glycol, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrollidinone, propylene carbonate, a C1-C20 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and mixtures thereof.

The cellulose ester polymer composition may also contain various other additives and components. For instance, the composition can further comprise an antioxidant, a stabilizer, an organic acid, an oil, filler particles, glass fibers, a bio-based polymer other than the cellulose ester, a biodegradable enhancer, a foaming agent, or mixtures thereof. The composition can also contain a mineral filler, such as talc, calcium carbonate, a metal oxide, mica, or mixtures thereof. The polymer composition can also contain a coloring agent which can be a dye, a pigment, or mixtures thereof.

In one embodiment, the polymer composition is combined in a heated extruder or mixer and then extruded into strands that can then be cut into pellets. The pellets can then be used to produce various different molded articles. As an example, the polymer composition can be used to produce beverage holders, drinking straws, hot beverage pods, interior automotive parts, consumer appliance parts, medical device components, packaging and the like.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a drinking straw that may be made in accordance with the present disclosure;

FIG. 2 is a cross-sectional view of a beverage holder that may be made in accordance with the present disclosure;

FIG. 3 is a side view of one embodiment of a beverage pod that can be made in accordance with the present disclosure;

FIG. 4 is a cross-sectional view of a drinking bottle that may be made in accordance with the present disclosure;

FIG. 5 is a perspective view of an automotive interior illustrating various articles that may be made in accordance with the present disclosure;

FIG. 6 is a perspective view of cutlery made in accordance with the present disclosure;

FIG. 7 is a perspective view of a lid made in accordance with the present disclosure;

FIG. 8 is a perspective view of a container made in accordance with the present disclosure;

FIG. 9 illustrates one embodiment of a medical apparatus comprising a composition prepared according to the present disclosure;

FIG. 10 illustrates another embodiment of a medical apparatus comprising a composition prepared according to the present disclosure;

FIG. 11 illustrates still another embodiment of a medical apparatus comprising a composition prepared according to the present disclosure; and

FIG. 12 illustrates another embodiment of a medical apparatus comprising a composition prepared according to the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to polymer compositions containing a polysaccharide ester polymer, such as a cellulose ester polymer, with improved melt processing properties. Molded articles made from the polymer composition may possess improved physical properties. In addition, the polymer composition of the present disclosure can be formulated to be sustainable and biodegradable, and thus environmentally friendly. The polymer composition can be used to form all different types of products using any suitable molding technique, such as extrusion, injection molding, rotational molding, and the like. The polymer composition of the present disclosure is particularly well formulated for use in any of the processes described above.

In general, the polymer composition of the present disclosure contains a cellulose ester polymer, such as a cellulose acetate polymer, in combination with a chain scission agent and optionally a plasticizer. The chain scission agent is believed to react with the cellulose ester polymer and reduce the chain length of the polymer. In this manner, the chain scission agent can lower the overall molecular weight of the cellulose ester polymer as can be measured through intrinsic viscosity. For example, the chain scission agent can be added to the cellulose ester polymer in an amount sufficient to lower the intrinsic viscosity by greater than about 5%, such as by greater than about 10%, such as by greater than about 15%, such as by greater than about 20%, such as by greater than about 25%. The intrinsic viscosity is generally lowered by no more than about 80%, such as by no more than about 50%, such as by no more than about 30%, such as by no more than about 25%. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$\begin{matrix}I V = \left(\frac{k}{c}\right) \left(\text{antilog} \left(\left(log {n}_{r e t}\right) / k\right) - 1\right) \\ \text{where} {n}_{r e t} = \left(\frac{{t}_{1}}{{t}_{2}}\right) ,\end{matrix} \qquad \text{Equation 1}$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

By combining a chain scission agent with a cellulose ester polymer in accordance with the present disclosure, relatively high molecular weight cellulose ester polymers can be more easily melt processed into molded articles. In the past, such cellulose ester polymers were combined with copious amounts of a plasticizer in order to increase the melt flow rate of the composition sufficient for use in molding processes, such as injection molding. Although the use of a plasticizer has provided great benefits and advantages, high plasticizer amounts can cause adverse effects on the material properties, such as reduced modulus and stiffness. In addition, the heat deflection temperature can be negatively impacted. Through the process of the present disclosure, the use of plasticizers may be reduced or eliminated if desired. In other applications, however, conventional amounts of plasticizer may be used and benefits still may be obtained related to the melt flow properties of the composition, related to the physical properties of molded articles formed from the composition or related to the overall appearance of the molded articles.

In general, any suitable cellulose ester polymer can be incorporated into the polymer composition of the present disclosure. In one aspect, the cellulose ester polymer is a cellulose acetate.

Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses oftheMiscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the composition may be cellulose diacetate or cellulose triacetate. In one embodiment, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

The cellulose ester polymer can generally have a degree of substitution of greater than about 1.5, such as greater than about 2, such as greater than about 2.2, such as greater than about 2.3, such as greater than about 2.4, such as greater than about 2.5. The degree of substitution is generally less than about 3.1, such as less than about 2.9, such as less than about 2.8, such as less than about 2.7, such as less than about 2.65.

In general, the cellulose acetate can have a molecular weight of greater than about 10,000 g/mol, such as greater than about 20,000 g/mol, such as greater than about 30,000 g/mol, such as greater than about 40,000 g/mol, such as greater than about 50,000 g/mol. The molecular weight of the cellulose acetate is generally less than about 300,000 g/mol, such as less than about 250,000 g/mol, such as less than about 200,000 g/mol, such as less than about 150,000 g/mol, such as less than about 100,000 g/mol, such as less than about 90,000 g/mol, such as less than about 70,000 g/mol, such as less than about 50,000 g/mol. The molecular weights identified above refer to the number average molecular weight. Molecular weight can be determined using gel permeation chromatography using a polystyrene equivalent or standard.

The cellulose ester polymer or cellulose acetate can have an initial intrinsic viscosity (prior to being combined with the chain scission agent) of generally of from about 0.5 dL/g to about 2 dL/g, including all increments of 0.1 dL/g therebetween. Cellulose ester polymers having an intrinsic viscosity of greater than about 1.5 dL/g, such as greater than about 1.55 dL/g, such as greater than about 1.6 dL/g, such as greater than about 1.65 dL/g, such as greater than about 1.7 dL/g, and generally less than about 2 dL/g are particularly well suited for use in compositions made according to the present disclosure. It should be understood, however, that cellulose ester polymers having a lower intrinsic viscosity may also be useful in many applications. For example, in other embodiments, the intrinsic viscosity of the cellulose ester polymer prior to being combined with the chain scission agent can be less than about 1.4 dL/g, such as less than about 1.3 dL/g, and generally greater than about 0.6 dL/g, such as greater than about 0.8 dL/g, such as greater than about 1 dL/g, such as greater than about 1.2 dL/g.

After being combined with the chain scission agent, the intrinsic viscosity of the cellulose ester polymer can be greater than about 0.3 dL/g, such as greater than about 0.8 dL/g, such as greater than about 1 dL/g, such as greater than about 1.2 dL/g, such as greater than about 1.4 dL/g, such as greater than about 1.5 dL/g. The intrinsic viscosity is generally less than about 2 dL/g, such as less than about 1.8 dL/g, such as less than about 1.7 dL/g, such as less than about 1.65 dL/g.

In general, the cellulose ester polymer is present in the polymer composition in an amount from about 15% by weight to about 95% by weight, including all increments of 1% by weight therebetween. The cellulose acetate is generally present in the polymer composition in an amount greater than about 15% by weight, such as in an amount greater than about 25% by weight, such as in an amount greater than about 35% by weight, such as in an amount greater than about 45% by weight, such as in an amount greater than about 55% by weight, such as in an amount greater than about 65% by weight, such as in an amount greater than about 75% by weight, such as in an amount greater than about 85% by weight. The cellulose acetate is generally present in the polymer composition in an amount less than about 90% by weight, such as in an amount less than about 85% by weight, such as in an amount less than about 75% by weight, such as in an amount less than about 70% by weight, such as in an amount less than about 65% by weight.

In accordance with the present disclosure, the polysaccharide ester polymer or cellulose ester polymer is combined with at least one chain scission agent. The chain scission agent reacts with the cellulose ester polymer in a way that reduces the intrinsic viscosity of the polymer. In this manner, the resulting cellulose ester polymer has improved flow properties during melt processing and is believed to have a molecular weight distribution that is better suited to producing molded articles with more uniform properties.

In one aspect, the chain scission agent is an acidic species having medium to mild acidity. For example, the chain scission agent can be an acidic species having a Pka value of from about 1 to about 8, including all increments of 0.1 therebetween. Some acidic species have more than one Pka value. In accordance with the present disclosure, the acidic species can have at least one Pka value within the above range and may be suitable for use in the composition of the present disclosure. In various embodiments, the chain scission agent can have a Pka value of greater than about 2.5, such as greater than about 3, such as greater than about 3.2, such as greater than about 3.5, such as greater than about 3.7, such as greater than about 4, such as greater than about 4.2. The Pka value of the chain scission agent is generally less than about 7, such as less than about 6.5, such as less than about 6.2, such as less than about 6, such as less than about 5.8, such as less than about 5.5.

Various different types of acidic species may be used as the chain scission agent. In one embodiment, the chain scission agent includes terminal hydroxyl groups, such as terminal carboxyl groups. For instance, the acidic species can contain greater than two, such as greater than three, such as greater than four, and generally less than about eight, such as less than about six terminal hydroxyl groups.

In one embodiment, the acidic species can be an organic acid. One particular organic acid well suited for use in the composition of the present disclosure is citric acid. Other acids well suited for use in the present disclosure include stearic acid and oxalic acid. In still other embodiments, the chain scission agent can be palmitic acid, linoleic acid, lactic acid, acetic acid, formic acid, malic acid, ascorbic acid, peracetic acid, and the like. Any of the above chain scission agents can be used alone or in combination. For example, citric acid may be used in combination with stearic acid and/or oxalic acid.

The amount of chain scission agent incorporated into the polymer composition can depend upon various factors including the molecular weight of the polysaccharide ester polymer, the amount and type of plasticizer that may be incorporated into the composition, and the desired resulting melt flow rate of the composition. In general, one or more chain scission agents can be present in the composition in an amount from about 0.05% to about 10% by weight, including all increments of 0.1% by weight therebetween. For example, one or more chain scission agents can be present in the composition in an amount greater than about 0.5% by weight, such as in an amount greater than about 0.8% by weight, such as in an amount greater than about 1% by weight, such as in an amount greater than about 1.2% by weight, such as in an amount greater than about 1.4% by weight, such as in an amount greater than about 1.6% by weight, such as in an amount greater than about 1.8% by weight, such as in an amount greater than about 2% by weight, such as in an amount greater than about 2.2% by weight, such as in an amount greater than about 2.4% by weight, such as in an amount greater than about 2.6% by weight. One or more chain scission agents are generally present in the composition in an amount less than about 8% by weight, such as in an amount less than about 6% by weight, such as in an amount less than about 5% by weight, such as in an amount less than about 4.5% by weight, such as in an amount less than about 4% by weight, such as in an amount less than about 3.5% by weight, such as in an amount less than about 3% by weight.

The polymer composition of the present disclosure can also optionally include one or more plasticizers. Plasticizers particularly well suited for use in the polymer composition include triacetin, monoacetin, diacetin, and mixtures thereof. Other suitable plasticizers include tris(clorisopropyl) phosphate, tris(2-chloro-1-methylethyl) phosphate, triethyl citrate, acetyl triethyl citrate, glycerin, or mixtures thereof. In an alternative embodiment, the plasticizer can be a polyethylene glycol. In still another embodiment, the plasticizer can be a polycaprolactone.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., .gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

The plasticizer can also be bio-based. For example, using a bio-based plasticizer can render the polymer composition well suited for contact with food items. Bio-based plasticizers particularly well suited for use in the composition of the present disclosure include an alkyl ketal ester, a non-petroleum hydrocarbon ester, a bio-based polymer or oligomer, such as polycaprolactone, having a number average molecular weight of 1000 or less, or mixtures thereof.

In one aspect, the bio-based plasticizer is an alkyl ketal ester having a chemical structure corresponding to Structure I as provided below:

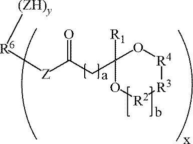

wherein a is from 0 to 12; b is 0 or 1; each R¹ is independently hydrogen, a hydrocarbyl group, or a substituted hydrocarbyl group; each R², R³, and R⁴ are independently methylene, alkylmethylene, or dialkylmethylene, x is at least 1, y is 0 or a positive number and x+y is at least 2; R⁶ is a hydrocarbyl group or a substituted hydrocarbyl group and each Z is independently —O—, —NH— or —NR— where R is a hydrocarbyl group or a substituted hydrocarbyl group.

The plasticizer identified above corresponds to a reaction product of a polyol, aminoalcohol or polyamine and certain 1,2- and/or 1,3-alkanediol ketal of an oxocarboxylate esters. 1,2- and 1,3-alkanediols ketals of oxocarboxylate esters are referred to herein as “alkyl ketal esters”. Up to one mole of alkyl ketal ester can be reacted per equivalent of hydroxyl groups or amino groups provided by the polyol, aminoalcohol or polyamine. The polyol, aminoalcohol or polyamine is most preferably difunctional, but polyols, aminoalcohols and polyamines having more than two hydroxyl and/or amino groups can be used.

The values of x and y in structure I will depend on the number of hydroxyl groups or amino groups on the polyol, aminoalcohol or polyamine, the number of moles of the alkyl ketal ester per mole of the polyol, aminoalcohol or polyamine, and the extent to which the reaction is taken towards completion. Higher amounts of the alkyl ketal ester favor lower values for y and higher values of x.

In structure I, y is specifically from 0 to 2 and x is specifically at least 2. All a in structure I are specifically 2 to 12, more specifically, 2 to 10, more specifically, 2 to 8, more specifically, 2 to 6, more specifically, 2 to 4, and more specifically, 2. All R¹ are specifically an alkyl group, specifically methyl. In some embodiments of structure I, all Z are —O—, y is 0 and x is 2; these products correspond to a reaction of two moles of an alkyl ketal ester and one mole of a diol. In some other embodiments, all Z are —O—, y is 1 and x is 1; these products correspond to the reaction of one mole of the alkyl ketal ester and one mole of a diol.

In one embodiment, all b are 0. In another embodiment, all b are 1.

Some specific compounds according to structure I include those having the structure:

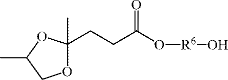

or the structure

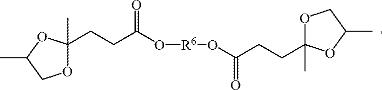

or the structure

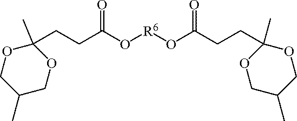

particularly in which R⁶ is —(CH₂)—ₘ wherein m is from 2 to 18, especially 2, 3, 4 or 6. In one specific embodiment, R⁶ corresponds to the residue, after removal of hydroxyl groups, of 1,4-butane diol resulting in the structure (la)

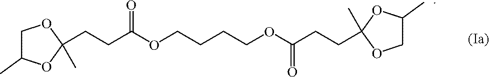

In another specific embodiment, R⁶ corresponds to the residue, after removal of hydroxyl groups, of diethylene glycol resulting in structure (Ib)

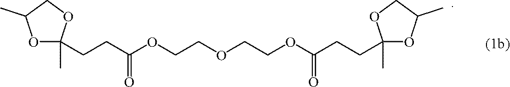

In another specific embodiment, R⁶ corresponds to the residue, after removal of hydroxyl groups, of 2-methyl. 1-3 propane diol resulting in structure (Ic)

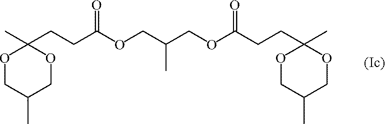

Compounds according to structure I can be prepared in a transesterification or ester-aminolysis reaction between the corresponding polyol, aminoalcohol or polyamine and the corresponding alkyl ketal ester. Alternatively, compounds according to structure I can be prepared by reacting an oxocarboxylic acid with the polyol, aminoalcohol or polyamine to form an ester or amide, and then ketalizing the resulting product with a 1,2- or 1,3-alkane diol such as ethylene glycol, 1,2-propanediol, 1,3-propanediol, 2-methyl, 1-3 propane diol, 1,2-butanediol, 1,3-butanediol, 1,2-pentanediol, 1,3-pentanediol, 1,2-hexanediol, 1,3-hexanediol, and the like.

Alkyl ketal ester plasticizers are particularly well suited for use in conjunction with one or more other plasticizers. For example, in one aspect, an alkyl ketal ester plasticizer can be combined with a benzoate ester. The weight ratio between the two plasticizers can vary such as from about 1:10 to about 10:1, such as from about 1:4 to about 4:1.

Another bio-based plasticizer that may be incorporated into the polymer composition of the present disclosure is a non-petroleum hydrocarbon ester. For example, one example of a non-petroleum hydrocarbon ester is sold under the tradename HALLGREEN by the Hall Star Company of Chicago, Illinois. Non-petroleum hydrocarbon ester plasticizers, for instance, can contain greater than about 50% by weight, such as greater than about 70% by weight, such as greater than about 99% by weight of bio-based content. The esters, for instance, can be derived primarily from agricultural, forestry, or marine materials and thus are biodegradable. In one aspect, the non-petroleum hydrocarbon ester plasticizer has a specific gravity at 25° C. of about 1.16 or greater, such as about 1.165 or greater, such as about 1.17 or greater, such as about 1.74 or greater, and generally about 1.19 or less, such as about 1.185 or less, such as about 1.18 or less, such as about 1.78 or less. The non-petroleum hydrocarbon ester plasticizer can have an acid value of from about 0.5 mgKOH/g to about 0.6 mgKOH/g, such as from about 0.53 mgKOH/g to about 0.57 mgKOH/g.

In another aspect, the polymer composition contains a bio-based plasticizer that is a bio-based polyester, such as a bio-based aliphatic polyester having a relatively low molecular weight. For example, the plasticizer can comprise a bio-based polyester polymer having a number average molecular weight of less than about 1000, such as less than about 900, such as less than about 800, and generally greater than about 500. In one embodiment, the bio-based plasticizer is a polycaprolactone having a number average molecular weight of 1000 or less. Alternatively, the bio-based plasticizer may be a polyhydroxyalkanoate having a number average molecular weight of 1000 or less.

In one aspect, the plasticizer is phthalate-free. In fact, the polymer composition can be formulated to be phthalate-free. For instance, phthalates can be present in the polymer composition in an amount of about 0.5% or less, such as in an amount of about 0.1% or less.

In general, one or more plasticizers can be present in the polymer composition in an amount from about 3% to about 40% by weight, such as in an amount from about 8% to about 35% by weight. In the past, however, it was believed that relatively high amounts of plasticizer were needed in order to produce a cellulose acetate composition capable of being melt processed. However, the amount of plasticizer can be significantly and dramatically reduced without compromising the melt processing characteristics of the composition. For example, in one aspect, one or more plasticizers can be present in the polymer composition in an amount of about 19% or less, such as in an amount of about 17% or less, such as in an amount of about 15% or less, such as in an amount of about 13% or less, such as in an amount of about 10% or less. One or more plasticizers are generally present in an amount from about 3% or greater, such as in an amount of about 5% or greater.

The cellulose acetate can be present in relation to the plasticizer such that the weight ratio between the cellulose acetate and the one or more plasticizers is from about 60:40 to about 95:5, such as from about 70:30 to about 90:10.

As described above, the amount of the chain scission agent that is incorporated into the polymer composition can be used to control the melt flow rate of the composition. For example, in one embodiment, one or more chain scission agents can be incorporated into the composition in order to increase the melt flow rate by at least about 10%, such as by at least about 20%, such as by at least about 30%, such as by at least about 50%, such as by at least about 100%, such as by at least about 200%, such as by at least about 300%, such as by at least about 400%, such as by at least about 500%, such as by at least about 600%, such as by at least about 700%, such as by at least about 800%, and generally less than about 2,000%. Unless otherwise indicated, melt flow rate as used herein is determined at 190° C. and at a load of 2.16 kg according to ASTM Test D1238-13. Melt flow can also be determined at a load of 2.16 kg and at a temperature of 200 C or at a temperature of 210 C.

The melt flow rate of the polymer composition of the present disclosure can be from about 2 g/10 min to about 70 g/10 min. In one aspect, the melt flow rate is greater than about 7 g/10 min, such as greater than about 10 g/10 min, such as greater than about 12 g/10 min, such as greater than about 15 g/10 min, such as greater than about 18 g/10 min, such as greater than about 20 g/10 min, such as greater than about 22 g/10 min, and generally less than about 50 g/10 min, such as less than about 40 g/10 min, such as less than about 30 g/10 min.

In addition to a polysaccharide ester polymer, one or more chain scission agents, and optionally one or more plasticizers, the polymer composition of the present disclosure can contain various other additives and ingredients. For example, cellulose acetate, the one or more plasticizers and the one or more chain scission agents can also be combined with one or more bio-based polymers that are different than the cellulose acetate and the one or more plasticizers. As used herein, a “bio-based” polymer or plasticizer refers to a polymer, oligomer, or compound produced from at least partially renewable biomass sources, such as produced from plant matter or food waste. For example, a bio-based polymer can be a polymer produced from greater than 30% renewable resources, such as greater than about 40% renewable resources, such as greater than about 50% renewable resources, such as greater than about 60% renewable resources, such as greater than about 70% renewable resources, such as greater than about 80% renewable resources, such as greater than about 90% renewable resources. Bio-based polymers are to be distinguished from polymers derived from fossil resources such as petroleum. Bio-based polymers can be bio-derived meaning that the polymer originates from a biological source or produced via a biological reaction, such as through fermentation or other microorganism process. Although a cellulose ester polymer can be considered a bio-based polymer, the term herein refers to other bio-based substances that can be combined with cellulose ester polymers. The bio-based polymer can also be biodegradable.

In one aspect, the bio-based polymer can be a polyester polymer, such as an aliphatic polyester. Particular bio-based polymers that may be incorporated into the polymer composition include polyhydroxyalkanoates, polylactic acid, polycaprolactone, or mixtures thereof.

In one aspect, the at least one bio-based polymer combined with the cellulose acetate is a polyhydroxyalkanoate. The polyhydroxyalkanoate can be a homopolymer or a copolymer. Polyhydroxyalkanoates, also known as “PHAs”, are linear polyesters produced in nature by bacterial fermentation of sugar or lipids. More than 100 different monomers can be combined within this family to give materials with extremely different properties. Generally, they can be either thermoplastic or elastomeric materials, with melting-points ranging from 40 to 180° C. The most common type of PHAs is PHB (poly-beta-hydroxybutyrate). Poly(3-hydroxybutyrate) (PHB) is a type of a naturally occurring thermoplastic polymer currently produced microbially inside of the cell wall of a number of wild bacteria species or genetically modified bacteria or yeasts, etc. It is biodegradable and does not present environmental issues post disposal, i.e., articles made from PHB can be composted.

The one or monomers used to produce a PHA can significantly impact the physical properties of the polymer. For example, PHAs can be produced that are crystalline, semi-crystalline, or completely amorphous. For example, poly-4-hydroxybutyrate homopolymer can be completely amorphous with a glass transition temperature of less than about -30° C. and with no noticeable melting point temperature. Polyhydroxybutyrate-valerate copolymers also can be formulated to be semi-crystalline to amorphous having low stiffness characteristics.

Examples of monomer units that can be incorporated in PHAs include 2-hydroxybutyrate, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HH), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

In some embodiments, the PHA in the methods described herein is a homopolymer (where all monomer units are the same). Examples of PHA homopolymers include poly 3-hydroxyalkanoates (e.g., poly 3-hydroxypropionate (hereinafter referred to as P3HP)), poly 3-hydroxybutyrate (hereinafter referred to as P3HB) and poly 3-hydroxyvalerate, poly 4-hydroxyalkanoates (e.g., poly 4-hydroxybutyrate (hereinafter referred to as P4HB)), poly 4-hydroxyvalerate (hereinafter referred to as P4HV)) or poly 5-hydroxyalkanoates (e.g., poly 5-hydroxyvalerate (hereinafter referred to as P5HV)).

In certain embodiments, the PHA can be a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as P3HB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV).

An example of a PHA having 4 different monomer units would be PHB-co-3HH-co-3HO-co-3HD or PHB-co-3-HO-co-3HD-co-3HDd. Typically where the PHB3HX has 3 or more monomer units, the 3HB monomer is at least 70% by weight of the total monomers, such as greater than 90% by weight of the total monomers.

When present, one or more PHAs can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. One or more PHAs are generally present in the polymer composition in an amount of about 30% or less, such as in an amount of about 25% or less, such as in an amount of about 20% or less, such as in an amount of about 15% or less.

In addition to one or more PHAs, the polymer composition can contain various other bio-based polymers, such as a polylactic acid or a polycaprolactone. Polylactic acid also known as “PLAs” are well suited for combining with one or more PHAs. Polylactic acid polymers are generally stiffer and more rigid than PHAs and thus can be added to the polymer composition for further refining the properties of the overall formulation.

Polylactic acid may generally be derived from monomer units of any isomer of lactic acid, such as levorotory-lactic acid (“L-lactic acid”), dextrorotatory-lactic acid (“D-lactic acid”), meso-lactic acid, or mixtures thereof. Monomer units may also be formed from anhydrides of any isomer of lactic acid, including L-lactide, D-lactide, meso-lactide, or mixtures thereof. Cyclic dimers of such lactic acids and/or lactides may also be employed. Any known polymerization method, such as polycondensation or ring-opening polymerization, may be used to polymerize lactic acid. A small amount of a chain-extending agent (e.g., a diisocyanate compound, an epoxy compound or an acid anhydride) may also be employed. The polylactic acid may be a homopolymer or a copolymer, such as one that contains monomer units derived from L-lactic acid and monomer units derived from D-lactic acid. Although not required, the content of one of the monomer units derived from L-lactic acid and the monomer units derived from D-lactic acid is preferably about 85 mole % or more, in some embodiments about 90 mole % or more, and in some embodiments, about 95 mole % or more. Multiple polylactic acids, each having a different ratio between the monomer unit derived from L-lactic acid and the monomer unit derived from D-lactic acid, may be blended at an arbitrary percentage.

In one particular embodiment, the polylactic acid has the following general structure:

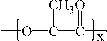

The polylactic acid typically has a number average molecular weight (“Mₙ”) ranging from about 40,000 to about 160,000 grams per mole, in some embodiments from about 50,000 to about 140,000 grams per mole, and in some embodiments, from about 80,000 to about 120,000 grams per mole. Likewise, the polymer also typically has a weight average molecular weight (“M_{w}”) ranging from about 80,000 to about 200,000 grams per mole, in some embodiments from about 100,000 to about 180,000 grams per mole, and in some embodiments, from about 110,000 to about 160,000 grams per mole. The ratio of the weight average molecular weight to the number average molecular weight (“M_{w}/Mₙ”), i.e., the “polydispersity index”, is also relatively low. For example, the polydispersity index typically ranges from about 1.0 to about 3.0, in some embodiments from about 1.1 to about 2.0, and in some embodiments, from about 1.2 to about 1.8. The weight and number average molecular weights may be determined by methods known to those skilled in the art.

Polylactic acid can be present in the polymer composition in an amount of about 1% or greater, such as in an amount of about 3% or greater, such as in an amount of about 5% or greater, and generally in an amount of about 20% or less, such as in an amount of about 15% or less, such as in an amount of about 10% or less, such as in an amount of about 8% or less.

As described above, another bio-based polymer that may be combined with cellulose acetate alone or in conjunction with other bio-based polymers is polycaprolactone having a molecular weight higher than a polycaprolactone plasticizer. Polycaprolactone, similar to PHAs, can be formulated to have a relatively low glass transition temperature. The glass transition temperature, for instance, can be less than about 10° C., such as less than about -5° C., such as less than about -20° C., and generally greater than about -60° C. The polymers can be produced so as to be amorphous or semi-crystalline. The crystallinity of the polymers can be less than about 50%, such as less than about 25%.

Polycaprolactones can be made having a number average molecular weight of generally greater than about 5,000, such as greater than about 8,000, and generally less than about 15,000, such as less than about 12,000.

Polycaprolactones can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. Polycaprolactones are generally present in the polymer composition in an amount of about 30% or less, such as in an amount of about 25% or less, such as in an amount of about 20% or less, such as in an amount of about 15% or less.

Other bio-based polymers that may be incorporated into the polymer composition include polybutylene succinate, polybutylene adipate terephthalate, a plasticized starch, other starch-based polymers, and the like. In addition, the bio-based polymer can be a polyolefin or polyester polymer made from renewable resources. For example, such polymers include bio-based polyethylene, bio-based polybutylene terephthalate, and the like.

In one aspect, an acid scavenger can also be present in the polymer composition. The acid scavenger can be a carbonate, an oxide, a hydroxide, an amine, or mixtures thereof. Examples of acid scavengers include zinc oxide, magnesium oxide, magnesium hydroxide, aluminum sodium carbonate, an aluminum silicate, a hydrotalcite, or mixtures thereof. One or more acid scavengers can be present in the polymer composition generally in an amount greater than about 0.1% by weight, such as greater than about 0.5% by weight, such as greater than about 1% by weight, and generally less than about 2.5% by weight, such as less than about 2% by weight, such as less than about 1.5% by weight.

The polymer composition may also contain antioxidants, pigments, lubricants, softening agents, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1% or greater, such as in an amount of about 0.3% or greater.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

In one embodiment, the polymer composition contains an antioxidant comprising a phosphorus compound, particularly a phosphite. For instance, in one embodiment, the antioxidant can be a diphosphite. For example, in one embodiment, the antioxidant is a pentaerythritol diphosphite, such as bis(2,4-dicumylphenyl)pentaerythritol diphosphite. The antioxidant can be present in the polymer composition generally in an amount less than about 2% by weight, such as in an amount less than about 1% by weight, such as in an amount less than about 0.5% by weight, such as in an amount less than about 0.3% by weight. The antioxidant can be present in the polymer composition generally in an amount greater than about 0.05% by weight, such as in an amount greater than about 0.08% by weight, such as in an amount greater than about 0.1% by weight, such as in an amount greater than about 0.13% by weight.

The polymer composition of the present disclosure can be formed into any suitable polymer article using any technique known in the art. For instance, polymer articles can be formed from the polymer composition through extrusion, injection molding, blow molding, and the like.

In one aspect, the polymer composition containing the cellulose acetate can be formulated such that the polymer composition has properties very comparable to petroleum-based polymers, such as polypropylene. By matching the physical properties of a petroleum-based polymer, the polymer composition of the present disclosure is well suited to replacing those polymers in many different end use applications.

Polymer articles that may be made in accordance with the present disclosure include drinking straws, beverage holders, automotive parts, knobs, door handles, consumer appliance parts, and the like.

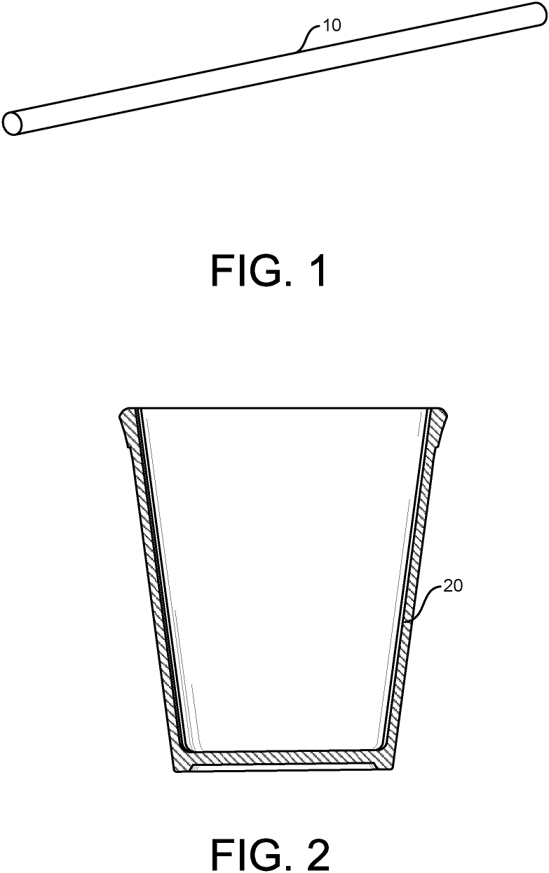

For instance, referring to FIG. 1, a drinking straw 10 is shown that can be made in accordance with the present disclosure. In the past, drinking straws were conventionally made from petroleum-based polymers, such as polypropylene. The cellulose acetate polymer composition of the present disclosure, however, can be formulated so as to match the physical properties of polypropylene. Thus, drinking straws 10 can be produced in accordance with the present disclosure and be completely biodegradable.

Referring to FIG. 2, a cup or beverage holder 20 is shown that can also be made in accordance with the present disclosure. The cup 20 can be made, for instance, using injection molding or through any suitable thermoforming process. As shown in FIG. 7, a lid 22 for the cup 20 can also be made from the polymer composition of the present disclosure. The lid can include a pour spout 24 for dispensing a beverage from the cup 20. In addition to lids for beverage holders, the polymer composition of the present disclosure can be used to make lids for all different types of containers, including food containers, package containers, storage containers and the like.

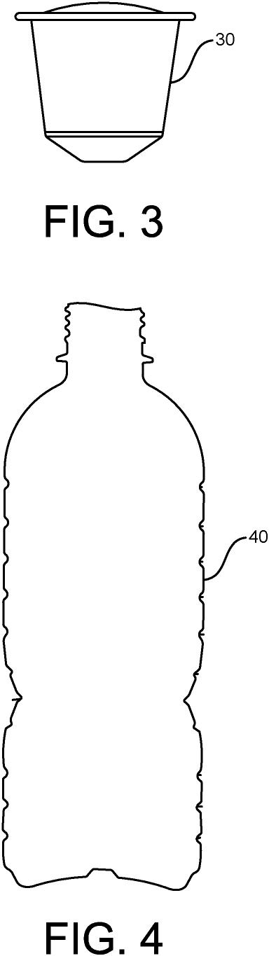

In still another embodiment, the polymer composition can be used to produce a hot beverage pod 30 as shown in FIG. 3. In addition to the beverage pod 30, the polymer composition can also be used to produce a plastic bottle 40 as shown in FIG. 4, which can serve as a water bottle or other sport drink container.

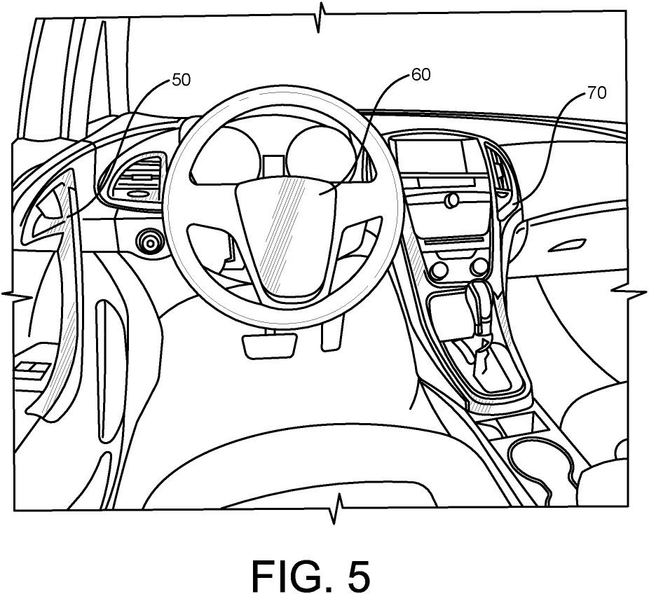

Referring to FIG. 5, an automotive interior is illustrated. The automotive interior includes various automotive parts that may be made in accordance with the present disclosure. The polymer composition, for instance, can be used to produce automotive part 50, which comprises at least a portion of an interior door handle. The polymer composition may also be used to produce a part on the steering column, such as automotive part 60. In general, the polymer composition can be used to mold any suitable decorative trim piece or bezel, such as trim piece 70. In addition, the polymer composition can be used to produce knobs or handles that may be used on the interior of the vehicle.

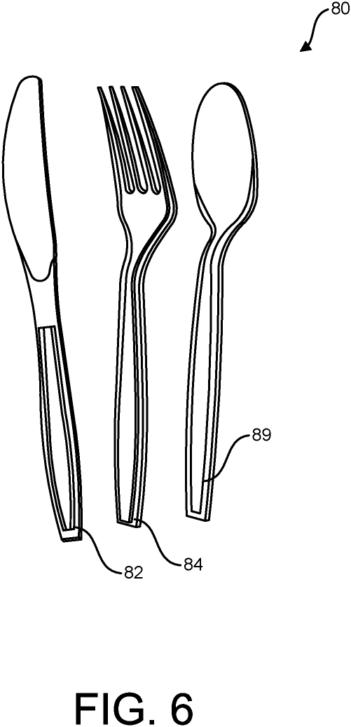

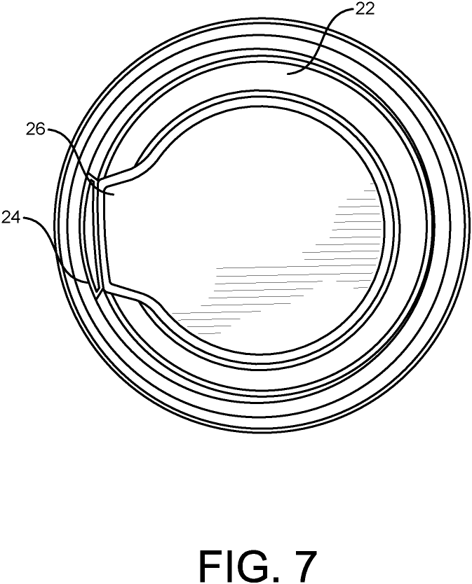

The polymer composition is also well suited to producing cutlery, such as forks, spoons, and knives. For example, referring to FIG. 6, disposable cutlery 80 is shown. The cutlery 80 includes a knife 82, a fork 84, and a spoon 86.

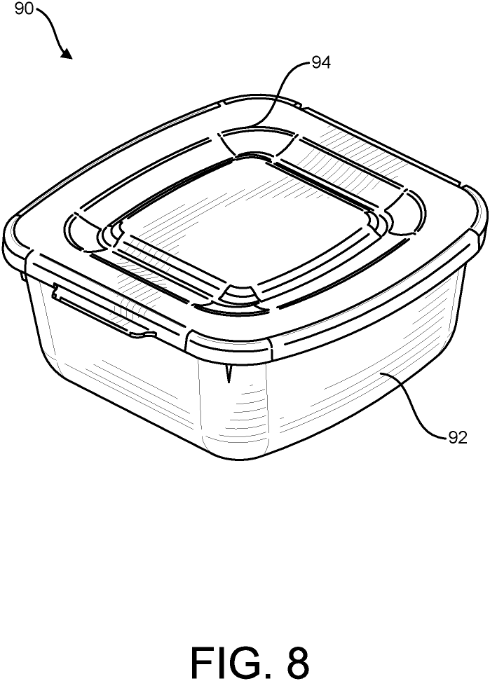

In still another embodiment, the polymer composition can be used to produce a storage container 90 as shown in FIG. 8. The storage container 90 can include a lid 94 that cooperates and engages the rim of a bottom 92. The bottom 92 can define an interior volume for holding items. The container 90 can be used to hold food items or dry goods.

In still other embodiments, the polymer composition can be formulated to produce paper plate liners, eyeglass frames, screwdriver handles, or any other suitable part.

The cellulose ester composition of the present disclosure is also particularly well-suited for use in producing medical devices including all different types of medical instruments. The cellulose ester composition, for instance, is well suited to replacing other polymers used in the past, such as polycarbonate polymers. Not only is the cellulose ester composition of the present disclosure biodegradable, but the composition has a unique “warm touch” feel when handled. Thus, the composition is particularly well suited for constructing housings for medical devices. When held or grasped, for instance, the polymer composition retains heat and makes the device or instrument feel warmer than devices made from other materials in the past. The sensation is particularly soothing and comforting to those in need of medical assistance and can also provide benefits to medical providers. In one aspect, the cellulose ester composition used to produce housings for medical devices includes a cellulose ester polymer combined with a plasticizer (e.g. triacetin) and optionally another bio-based polymer. In addition, the composition can contain one or more coloring agents.

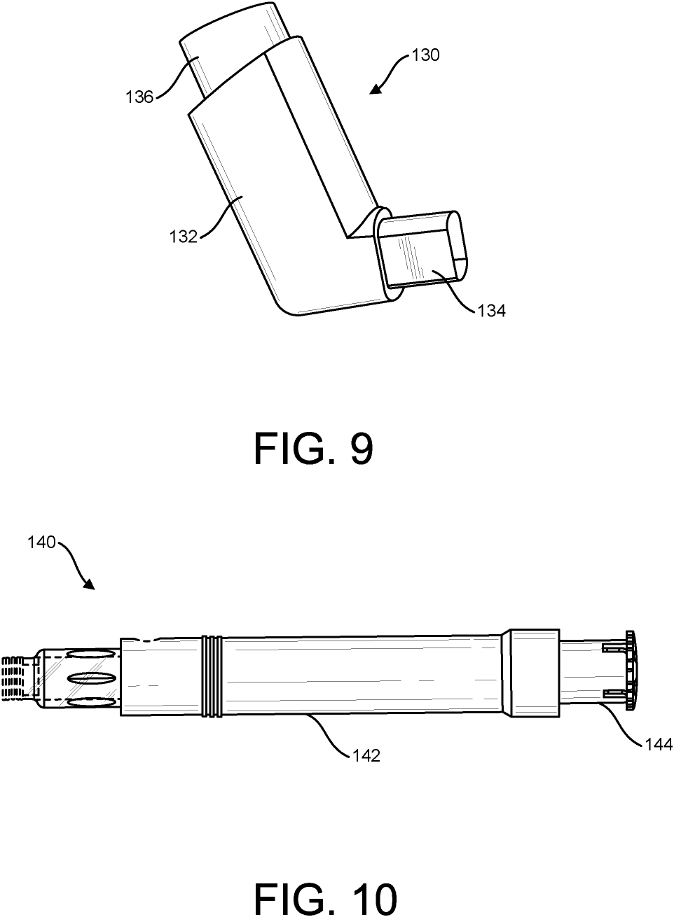

Referring to FIG. 9, for instance, an inhaler 130 is shown that may be made from the cellulose ester polymer composition. The inhaler 130 includes a housing 132 attached to a mouthpiece 134. In operative association with the housing 132 is a plunger 136 for receiving a canister containing a composition to be inhaled. The composition may comprise a spray or a powder.

During use, the inhaler 130 administers metered doses of a medication, such as an asthma medication to a patient. The asthma medication may be suspended or dissolved in a propellant or may be contained in a powder. When a patient actuates the inhaler to breathe in the medication, a valve opens allowing the medication to exit the mouthpiece. In accordance with the present disclosure, the housing 132, the mouthpiece 134 and the plunger 136 can all be made from a polymer composition as described above.

Referring to FIG. 10, another medical product that may be made in accordance with the present disclosure is shown. In FIG. 10, a medical injector 140 is illustrated. The medical injector 140 includes a housing 142 in operative association with a plunger 144. The housing 142 may slide relative to the plunger 144. The medical injector 140 may be spring loaded. The medical injector is for injecting a drug into a patient typically into the thigh or the buttocks. The medical injector can be needleless or may contain a needle. When containing a needle, the needle tip is typically shielded within the housing prior to injection. Needleless injectors, on the other hand, can contain a cylinder of pressurized gas that propels a medication through the skin without the use of a needle. In accordance with the present disclosure, the housing 142 and/or the plunger 144 can be made from a polymer composition as described above.

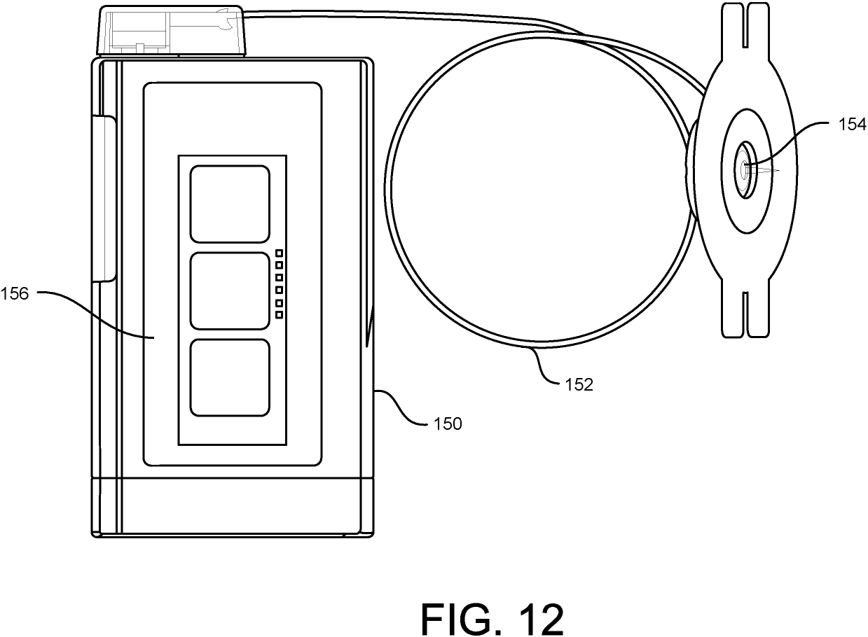

The medical injector 140 as shown in FIG. 10 can be used to inject insulin. Referring to FIG. 12, an insulin pump device 150 is illustrated that can include a housing 156 also made from the polymer composition of the present disclosure. The insulin pump device 150 can include a pump in fluid communication with tubing 152 and a needle 154 for subcutaneously injecting insulin into a patient.

The polymer composition of the present disclosure can also be used in all different types of laparoscopic devices. Laparoscopic surgery refers to surgical procedures that are performed through an existing opening in the body or through one or multiple small incisions. Laparoscopic devices include different types of laparoscopes, needle drivers, trocars, bowel graspers, rhinolaryngoscopes and the like.

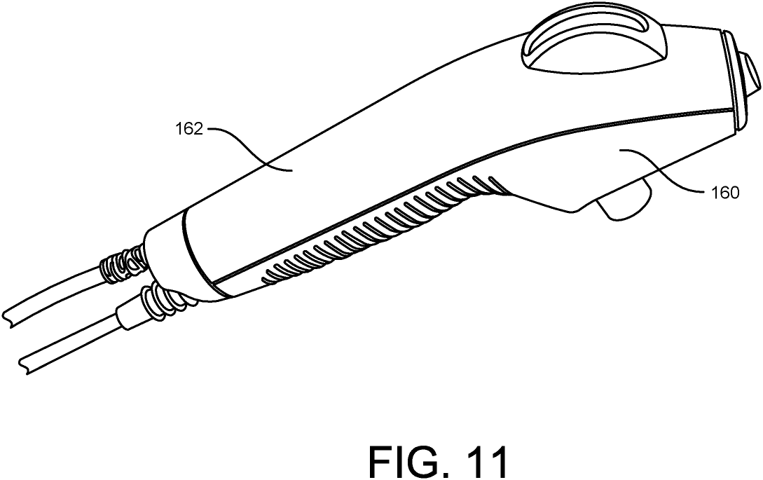

Referring to FIG. 11, for example, a rhinolaryngoscope 160 made in accordance with the present disclosure is shown. The rhinolaryngoscope 160 includes small, flexible plastic tubes with fiberoptics for viewing airways. The rhinolaryngoscope can be attached to a television camera to provide a permanent record of an examination. The rhinolaryngoscope 160 includes a housing 162 made from the polymer composition of the present disclosure. The rhinolaryngoscope 160 is for examining the nose and throat. With a rhinolaryngoscope, a doctor can examine most of the inside of the nose, the eustachian tube openings, the adenoids, the throat, and the vocal cords.

### EXAMPLES

### Example No. 1

A cellulose ester polymer was combined with a plasticizer and different amounts of citric acid. The resulting formulations were then tested for melt flow rate and/or subjected to GPC analysis. The following compositions were formulated:
Sample No. 1: Cellulose ester polymer 73.15%, triacetin 24%, citric acid 2.85%
Sample No. 2: Cellulose ester polymer 74.5%, triacetin 24%, citric acid 1.5%
Sample No. 3: Cellulose ester polymer 75.5%, triacetin 24%, citric acid 0.5%
Sample No. 4: Cellulose ester polymer 75.98%, triacetin 24%, citric acid 0.02%

The cellulose ester polymer incorporated into the above compositions contained primarily cellulose diacetate and had a degree of substitution of from about 2.45 to about 2.6. Sample Nos. 1 - 3 were tested for melt flow rate and the following results were obtained:

| Sample No. | Melt Flow Rate at 200° C., 2.16 kg load (g/10 min) | Melt Flow Rate at 190° C., 2.16 kg load (g/10 min) |
|---|---|---|
| 1 | 24.40 | 12.26 |
| 2 | | 23.81 |
| 3 | | 5.67 |

As shown above, as the amount of citric acid increased, the melt flow rate dramatically increased.

The following are the results of the GPC analysis that was conducted on extruded pellets:

### Example No. 2

Various cellulose ester polymer compositions were formulated and tested for flow properties. In this example, caprolactone was used as a plasticizer. In particular, a caprolactone plasticizer was added to the following compositions such that the resulting composition contained the caprolactone plasticizer in an amount of 25% by weight.
Sample No. 1: Cellulose ester polymer 100 parts, citric acid 2.85 parts, diphosphite stabilizer 1.5 parts
Sample No. 2: Cellulose ester polymer 100 parts, phosphite antioxidant 0.15 parts
Sample No. 3: Cellulose ester polymer 100 parts

The above formulations were tested for melt flow rate at 190° C. and at a load of 2.16 kg. The following results were obtained:

| Sample No. | Melt Flow Rate g/10 min |
|---|---|
| 1 | 27.6 |
| 1 | 25.45 |
| 1 | 23.09 |
| 1 | 22.16 |
| 2 | 2.91 |

| | |
|---|---|
| 2 | 3.25 |
| 2 | 4.11 |
| 2 | 4.11 |
| 2 | 3.95 |
| 3 | 4.44 |
| 3 | 5.39 |
| 3 | 3.86 |

Sample Nos. 1 and 3 were also tested for intrinsic viscosity. Two measurements were taken, one at 300 rpm and one at 600 rpm. The following results were obtained:

| Sample No. 1 (300 rpm) | Sample No. 1 (600 rpm) | Sample No. 3 (300 rpm) | Sample No. 3 (600 rpm) |
|---|---|---|---|
| Intrinisic viscosity by Solomon-Ciuta (dL/g) | | | |
| 1.26 | 1.18 | 1.59 | 1.55 |

As shown above, the intrinsic viscosity of the cellulose acetate polymer was significantly reduced by addition of the citric acid.

### Example No. 3

A cellulose ester polymer was combined with a plasticizer and different amounts of peracetic acid. Pellets were extruded and appeared transparent and clear. The resulting formulations were then tested for melt flow rate. The following compositions were formulated:
Sample No. 1: Cellulose ester polymer 75.5%, triacetin 24%, peracetic acid 0.5%
Sample No. 2: Cellulose ester polymer 75.9%, triacetin 24%, peracetic acid 0.1%

The cellulose ester polymer incorporated into the above compositions contained primarily cellulose diacetate and had a degree of substitution of from about 2.45 to about 2.6. Sample Nos. 1 and 2 were tested for melt flow rate and the following results were obtained:

| Sample No. | Melt Flow Rate at 210° C., 2.16 kg load (g/10 min) |
|---|---|
| 1 | 27.0 |
| 2 | 18.5 |

As shown, the melt flow rate increased as the amount of peracetic acid was increased.

The samples were also tested according to the CIELab color scale and compared to samples containing no acid and samples containing citric acid. The following additional samples were formulated:
Sample No. 3: Cellulose ester polymer 82%, triacetin 18%
Sample No. 4: Cellulose ester polymer 78%, triacetin 22%
Sample No. 5: Cellulose ester polymer 74%, triacetin 26%
Sample No. 6: Cellulose ester polymer 75.5%, triacetin 24%, citric acid 0.5%
Sample No. 7: Cellulose ester polymer 75.9%, triacetin 24%, citric acid 0.1%

As used herein, CIELab color values L*, a*, and b* are measured according to the color space specified by the International Commission on Illumination. The L*a*b* colourimetric system was standardized in 1976 by Commission Internationale de I′Eclairage (CIE). The CIELab L* value, utilized herein to define the darkness/lightness of the polymer composition, is a unit of colour measurement in the afore-mentioned CIELab system. A colour may be matched according to CIELab. In the L*a*b* colourimetric system, L* refers to lightness expressed by a numerical value. The following results were obtained:

| Sample No. | L | a | b |
|---|---|---|---|
| 3 | 62.86 | -1.23 | 10.5 |
| 4 | 62.20 | -1.08 | 9.97 |
| 5 | 62.16 | -1.12 | 8.96 |
| 6 | 60.16 | -0.70 | 9.23 |
| 7 | 61.84 | -0.79 | 9.21 |
| 1 | 62.07 | -0.88 | 10.25 |
| 2 | 62.81 | -1.1 | 10.67 |

As shown above, peracetic acid and citric acid had no negative impact on pellet color. The samples displayed and L value of greater than about 60, such as greater than about 61, such as greater than about 62 (and less than about 70).

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a cellulose ester polymer, the cellulose ester polymer being present in the polymer composition in an amount greater than about 40% by weight;
a plasticizer; and
a chain scission agent, the chain scission agent comprising an acidic species having a Pka value of from about 1 to about 8, the chain scission agent being present in an amount sufficient to increase a melt flow rate of the composition by greater than about 20% in comparison to the same composition without the chain scission agent and with the cellulose ester polymer in the same amount.

2. A polymer composition as defined in claim 1, wherein the chain scission agent has a Pka value of from about 2.5 to about 6.

3. A polymer composition as defined in claim 1, wherein the chain scission agent includes terminal hydroxyl groups.

4. A polymer composition as defined in claim 1, wherein the chain scission agent comprises an organic acid.

5. A polymer composition as defined in claim 1, wherein the chain scission agent comprises citric acid.

6. A polymer composition as defined in claim 1, wherein the chain scission agent comprises stearic acid, oxalic acid, or mixtures thereof.

7. A polymer composition as defined in claim 1, wherein the chain scission agent comprises palmitic acid, linoleic acid, lactic acid, acetic acid, formic acid, malic acid, ascorbic acid, peracetic acid, or mixtures thereof.

8. A polymer composition as defined in claim 1, wherein the chain scission agent is present in the polymer composition in an amount from about 0.05% by weight to about 10% by weight.

9. A polymer composition as defined in claim 1, wherein the cellulose ester polymer comprises a cellulose acetate having a degree of substitution of from about 1.5 to about 2.8, the cellulose ester polymer comprising cellulose diacetate.

10. A polymer composition as defined in claim 1, wherein the chain scission agent is present in the polymer composition sufficient to increase the melt flow rate by at least about 30%, and less than about 2,000%.

11. A polymer composition as defined in claim 1, wherein the cellulose ester polymer is present in the polymer composition in an amount from about 55% by weight to about 95% by weight, and the plasticizer is present in an amount from about 5% by weight to about 40% by weight.

12. A polymer composition as defined in claim 1, wherein the plasticizer comprises triacetin, polyethylene glycol, or mixtures thereof.

13. A polymer composition as defined in claim 1, wherein the cellulose ester product further comprises an antioxidant, a stabilizer, an organic acid, an oil, filler particles, glass fibers, a pigment, a bio-based polymer other than the cellulose ester, a biodegradable enhancer, a foaming agent, or mixtures thereof.

14. A polymer composition as defined in claim 1, wherein the cellulose ester product further comprises a mineral filler, the mineral filler comprising talc, calcium carbonate, a metal oxide, mica, or mixtures thereof.

15. A polymer composition as defined in claim 1, wherein the cellulose ester product further comprises a coloring agent, the coloring agent comprising an organic dye, an inorganic dye, a pigment, or mixtures thereof.

16. A melt extruded article made from the polymer composition as defined in claim 1.

17. A melt extruded article as defined in claim 16, wherein the article is a beverage holder, a drinking straw, a hot beverage pod, or an interior automotive part.

18. A process for producing a cellulose ester polymer product comprising:
combining cellulose ester polymer particles with a plasticizer and a chain scission agent; and
melt processing the cellulose ester polymer particles, plasticizer, and chain scission agent mixture into a plasticized cellulose ester polymer product, the chain scission agent being present in the product in an amount sufficient to increase a melt flow rate of the product.

19. A process as defined in claim 18, wherein the chain scission agent has a Pka value of from about 2.5 to about 6 and wherein the chain scission agent comprises an organic acid.

20. A process as defined in claim 19, wherein the chain scission agent comprises citric acid, stearic acid, oxalic acid, palmitic acid, linoleic acid, lactic acid, acetic acid, formic acid, malic acid, ascorbic acid, peracetic acid, or mixtures thereof.
